(19) United States
(12) Patent Application Publication
(10) Pub. No.: US 2004/0024710 A1
(43) Pub. Date: Feb. 5, 2004

(54) Secure input pad partition

(76) Inventors: Llavanya Fernando, San Jose, CA (US); Nathan C. Wang, San Jose, CA (US); G.F.R. Sulak Soysa, San Jose, CA (US)

Correspondence Address: DORSEY & WHITNEY LLP, Suite 3400, Four Embarcadero Center, San Francisco, CA, 94111-4187, US

(21) Appl. No.: 10/383,700

(22) Filed: Mar. 7, 2003

Related U.S. Application Data
(60) Provisional application No. 60/363,034, filed on Mar. 7, 2002.

(51) Int. Cl. G06F 17/60

(52) U.S. Cl. 705/50; 705/39

(57) ABSTRACT

A transaction device is operable in a secure mode in which user private information data is protected against use of unauthorized access, or in an unsecured mode that allows public data to flow freely. In secure mode, private user information data is selectively encrypted before transmission. The transaction device can selectively display an input pad partition template, based upon the secure or non-secure present mode of operation. Display of the input pad partition enables the device user to confidently input user private information for secure transmission from the device.

### RELATIONSHIP TO PENDING APPLICATION

Priority is claimed from U.S. provisional patent application serial No. 60/363,034 filed by applicants herein on Mar. 7, 2002, entitled “Active Noise Injection and Secure Input Pad Partition”.

### FIELD OF THE INVENTION

The invention relates generally to electronic transaction devices including point of sale (POS) devices, and more particularly to increasing the security of data within such devices.

### BACKGROUND OF THE INVENTION

In recent years, electronic transaction devices such as point of sale (POS) devices, ATMs, personal digital assistants (PDAs), personal computers (PCs), and bank system networks have found much use in commerce. Transactions involving such devices are carried out everyday over media including the Internet, as well as through POS or bank system networks. Such transactions typically request from the customer-user private information such as a personal identification number (PIN), signature, password, or some other form of private identification. A merchant involved in the transaction uses such private information to verify authenticity of the user's identity, and to authorize the transaction.

Understandably it is important that such private information be protected from access by authorized parties. Should such private information fall into the wrong hands, the user may be at risk for identity theft and for fraudulent transactions, perhaps the user's credit card information. The unauthorized party may utilize the user's private information to fraudulently perform transactions ostensibly on behalf of the unsuspecting user. Prior art systems are designed to try to maintain integrity of user private information when such information is transmitted or promulgated from the transaction device to a remote device.

One prior art technique used in an attempt to ensure integrity of user private information is to encrypt all the information transmitted from the transaction device to a remote device. Encrypting information is a resource intensive operation, and encrypting all information, private and public, passing from a transaction device can unduly tax system resources of the associated transaction device.

What is needed is a method and mechanism by which private user information communicated from a transaction device can be protected during a transaction, without substantially taxing system resources associated with the transaction device.

The present invention provides such a method and mechanism to enhanced security of user private information communicated from a transaction device.

### SUMMARY OF THE INVENTION

The present invention provides a transaction device that can operate in a secure mode such that user private information data is protected against use of unauthorized parties, or in an unsecured mode that allows public data to flow freely. The transaction device selectively encrypts data before transmission from the transaction device to a remote device, depending upon whether the transaction is occurring under secure mode or under non-secure mode. Further, the transaction device can selectively display a relevant image (including a message) for the user, and then apply a partition template to the user-input data, based upon the secure or non-secure present mode of operation. If the input pad partition is displayed, the device user can input private data into the input pad partition with confidence that the device is now operating in a secure mode. If the device is operating in a non-secure mode, the template is such that only a very small and restricted area of the input pad is available for any user input, thus reducing a hacker's ability to display a spurious PIN pad that might invite the user to input private data.

Other aspects and advantages of the invention will become apparent from the following detailed description, taken in conjunction with the accompanying drawings, illustrated by way of example of the principles of the invention.

### BRIEF DESCRIPTION OF THE DRAWINGS

FIG. 1 depicts an exemplary embodiment of a transaction device, according to the present invention;

FIG. 2 depicts a simplified block diagram of an exemplary transaction device, according to the present invention;

FIG. 3 depicts an input pad partition template for a transaction device currently in non-secure mode, according to the present invention;

FIG. 4 depicts an alternative embodiment of an input pad partition template of a transaction device currently in secure mode, according to the present invention;

FIG. 5 depicts yet another embodiment of an input pad partition template of a transaction device, according to the present invention;

FIG. 6 is a generic flow diagram depicting the display of an input pad partition template for a transaction device, according to the present invention; and

FIG. 7 is a generic flow diagram depicting selective encryption of input information in a transaction device, according to the present invention.

### DETAILED DESCRIPTION OF THE PREFERRED EMBODIMENTS

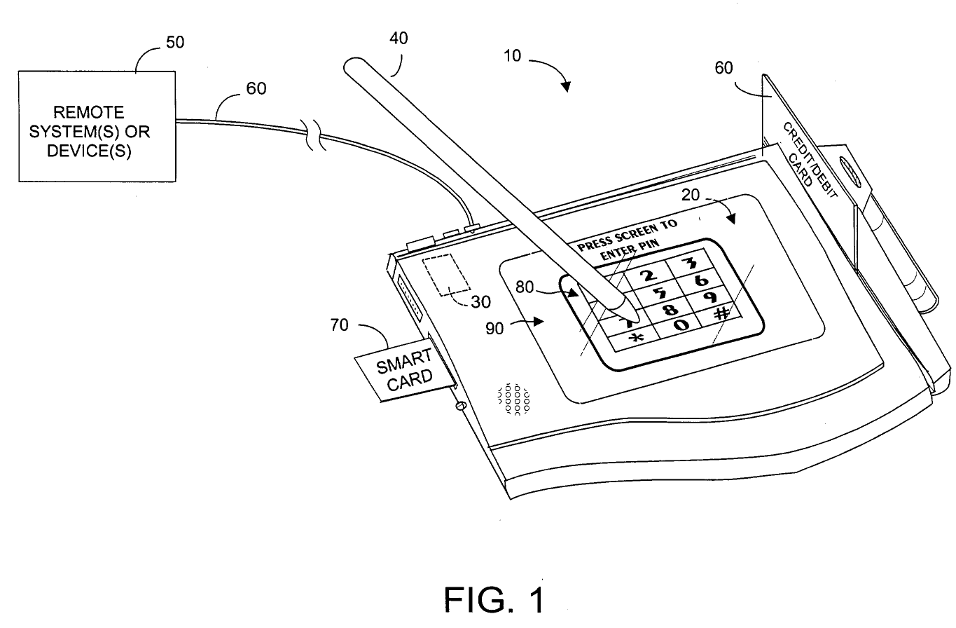

FIG. 1 depicts an exemplary embodiment of a transaction device 10 configured for operation by a user. Although device 10 is shown as a point-of-sale (POS) device such as may be used when paying for a transaction at a merchant store, it is understood that device 10 could instead be a personal digital assistant (PDA), a personal computer, a kiosk terminal, and so forth.

In an exemplary embodiment, transaction device 10 includes a screen 20 that preferably can display information for the user and can also be used to receive information input by the user, for example a screen sensitive to at least one of touch, pressure, electrical charge, interruption of light, and heat resulting from user interface with the screen. Device 10 typically operates responsive to internal electronics 30. In one embodiment, screen 20 is configured to both display information to the user and receive input from the user, for example using a stylus 40 (that may be a passive stylus), or even the user's finger. In the embodiment shown in FIG. 1, device 10 can receive a user's credit/debit card 60 and/or a user's smart card 70.

It is understood that the above description of device 10 is intended to be general, and in some devices separate screens for device display and for user input may be provided. In many applications, transaction device 10 can communicate with other device(s) or system(s) 50 via one or more communications paths 60 that may include hard wiring, wireless communications including, for example, use of infrared, radio frequency, microwave energies, cellular telephony systems, Bluetooth communications, and so forth.

According to the present invention, device 10 preferably operates in a secure mode, to protect the user's private data from being utilized by unauthorized parties, and in a non-secure mode that allows public data to flow more freely, e.g., from device 10 to system 50. Accordingly device 10 selectively encrypts user private data before transmission to remote system 50, for example using well known encryption algorithms such as DES, Triple DES, and the like. Device 10 preferably also uses a cipher key management scheme such as DUKPT, Master/Session, and the like to promote user data security. Such processes may be understood to be carried out by electronics 30.

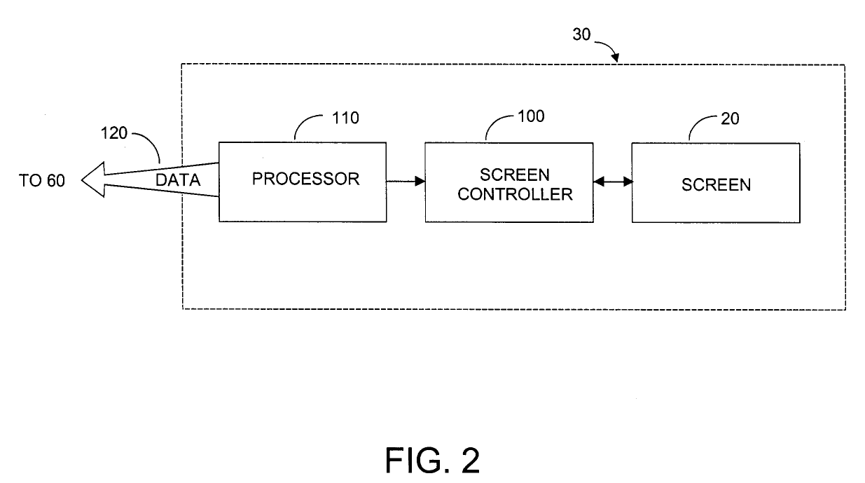

Further and advantageously, transaction device 10 can selectively display an input pad partition template 80, based upon whether device 10 is operating at present in secure mode or non-secure mode. Determination of whether device 10 presently operates in secure mode or non-secure mode can be made by a processor within device 10 (e.g., processor 110, FIG. 2) and/or by a processor associated with a remote device or system 60 (see FIG. 1). Thus in FIG. 1, display 20 comprises a input pad partition template 80 (in which a user can see a so-called soft personal identification number (PIN) pad for use in inputting numerical pin or other data, for example using stylus 40) and a remaining display region 90. Since FIG. 1 shows input pad partition template region 80 as being visible to the user, device 10 is operating in secure mode. If device 10 were operating in non-secure mode, no PIN pad would be visible to the user (e.g., input partition template region 80 would not be visible), and preferably even random user contract with the central portion of display 20 (upon which partition region 90 is defineable) would not result in input to device 10.

FIG. 2 is a simplified block diagram of electronics 30 within transaction device 10, according to the present invention. Electronics 30 includes and/or controls the combination display/input screen 20, a display/input screen controller 100, and a processor 110, coupled as shown in FIG. 2. If desired, screen controller 100 may be housed within display/input screen 20 to enhance security by making it difficult for a would be hacker to physically gain access to the screen controller and to private user information.

In one embodiment, screen controller 110 is configured to receive information for display on screen 20 from processor 110, and to instruct display/input screen 20 to output the display information for user viewing. Screen controller 100 may modify the format of display information for the display/input screen 30, based upon whether transaction device 10 is operating in secure mode or in non-secure mode.

Screen controller 100 preferably is also configured to receive input information from display/input screen 20, for example information input by user interaction with the screen itself. User information input via display/input screen 10 describes a particular location on the surface of the display/input screen, for example (x,y) coordinates. Screen controller 100 receives this input information from display/input screen 20 and transmits the input information to processor 110.

In this embodiment, screen controller 100 instructs processor 110 either to suppress the input information, to pass this information onto a remote system (e.g., system 50) without encryption, or to first encrypt and then transmit the information to a remote system (e.g., system 50). Screen controller 100 provides these instructions to processor 110 based upon a specific location of the input information relative to the display/input screen 20 (for example, a location falling within region 80 or within region 90, in FIG. 1), and based upon whether transaction device 10 is operating in secure mode or in non-secure mode.

In another embodiment, processor 110 (rather than screen controller 100) decides whether to suppress the input information, to pass the information onto a remote device (e.g., system 50) unencrypted, or to first encrypt the information before it is transmitted to a remote device or system (e.g., system 50). As such, processor 110 is configured to communicate with and to instruct screen controller 100 to operate in a secure mode or non-secure mode, depending on the display information. If desired, processor 110 may be configured to receive display information from a remote device as opposed to receiving the information solely locally from device 10.

Thus, processor 110 is configured to selectively transmit input information to a remote system (e.g., system 50), based upon the specific location of the input information relative to the display/input screen 20, and based upon whether transaction device 10 is operating in secure mode or in non-secure mode. Processor 230 preferably is configured to selectively encrypt the input information before transmission to a remote system (e.g., 50), based on the specific location of the input information relative to the display/input screen 20 (e.g., region 80 or region 90 in FIG. 1), and based upon the current mode of operation of device 10, e.g., secure mode or non-secure mode. In FIG. 2, data flow arrow 120 represents transmission of input information from processor 110 to a remote system 50, beyond and external to transaction device 10.

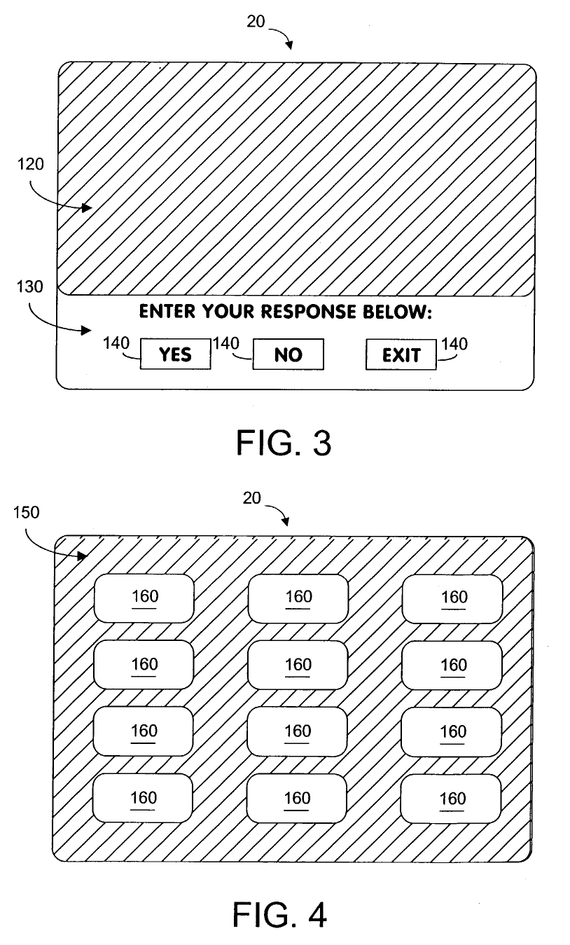

FIG. 3 is an example of display/input screen 20 in device 10 operating in non-secure mode. As such display/input screen 20 is partitioned into regions, here two regions, denoted 120 and 130. The larger region 120 is depicted with shading in FIG. 3 to denote that region 120 is not available for user input, due to the non-secure mode of operation, whereas smaller region 130 is available for user input. In practice region 120 need not actually appear on display/input screen 20 with shading; the shading is used in FIG. 3 simply to denote a partition region that is not available to the user due to the non-secure mode of operation of device 10. Region 120 preferably is larger than region 130 to make it more difficult for hacker simply to poke about at different areas of the region in an attempt to input private user data, for example a PIN, a password, etc. Preferably the region of display 20 presently non-available to the user (here region 120) can be made electronically non-responsive to user (or hacker) contact with that portion of the display/input screen. Note that region 130 is intentionally displayed too small to encompass a virtual PIN pad, for example such as was depicted in FIG. 1.

In FIG. 3, user-input portion 130 may display information for the user and provide for user input of non-private information. Such generic functionality is depicted by the three displayed user-operable menu buttons 140. Thus, even if the user's input to region 130 were intercepted, the intercepted data would hardly be private data. As such, the input information entered within region 130 by the user is transmitted by transaction device 10 without encryption to a remote device or system 50. On the other hand, if region 120 is allowed to remain responsive to user input (even though no visual guidance to the user is shown in FIG. 3), any user contact that emulates input to region 120 would be encrypted before transmission as part of data flow 120 to remove device(s) or system(s) 50. Alternatively, any such information attempted to be input into region 120 would simply be suppressed by transaction device 10, and would not be included in data flow 120.

FIG. 4 depicts display/input screen 20 when transaction device 10 is operated in secure mode. In the embodiment shown, display/input screen 20 is partitioned into a plurality of segment regions 160, and a common single segment 150, which segment 150 is shown as being shaded. In this embodiment, segment regions 160 are available for user input, but region 150 of display/input screen 20 is not available (or is rendered non-responsive to user interface with this region).

In FIG. 4, the user-operable segments 160 could correspond, by way of example, to a virtual PIN pad such as shown in FIG. 1, where individual segments 160 represent different virtual input keys. Because transaction device 10 is now operating in secure mode, segments 160 are visible and available for input to the user, and any user interface with segments 160 (e.g., touching, pressure, heat, electrical charge, etc.) will be encrypted before transmission as part of data flow 120 out of device 10, for example to remote device(s) or system(s) 50. Any user interface, intended or not, with region 150 will be suppressed and will not result in transmission of data from device 10.

In FIG. 4, an advantage of making segments 160 encompass a substantial portion of overall display/input screen 20 is that it becomes more difficult for an unauthorized party or hacker to trick the user into entering a PIN or password on a virtual keypad within portion 150. Portion 150 is intentionally made too small to effectively display a virtual keypad with which a user might be tricked into inputting what would be private data into device 10. It is understood that FIG. 3 and FIG. 4 are merely exemplary and are intended to convey the types of different displays viewed by a user, depending upon the current mode of operation of transaction device 10. Thus, more or less user-operable regions 160 than are shown in FIG. 4 could be used, some such regions could be made larger or differently shaped than others, and such regions could be adjacent one another without any intervening segment of region 150.

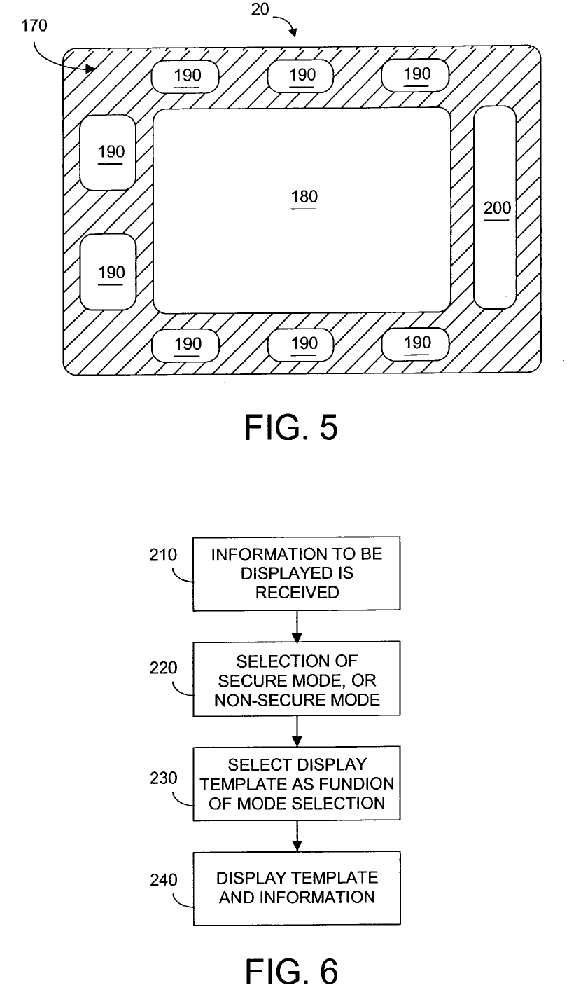

FIG. 5 depicts display/input screen 20 on a transaction device 10 operating in either a secure mode or non-secure mode. Display/input screen 20 is partitioned into a large region 180, a plurality of regions 190, and a segment 200. In this embodiment, when transaction device 10 is operating in secure mode, central portion 180 of display/input screen 20 is available to receive user-input information. In secure mode, if the user is invited by device 10 to input private data into portion 180, such input information received by portion 180 is encrypted before transmission outside of transaction device 10. When device 10 operates in a non-secure mode, any input (intended or otherwise) to region 180 preferably is suppressed and is not transmitted beyond device 10. It is understood that a variety of display elements may be caused to appear in region 180, including without limitation a virtual input PIN pad such as shown in FIG. 1, while device 10 is operating in secure mode.

Still referring to FIG. 5, when device 10 is operated in a non-secure mode, any user input information provided to regions 190, 200 may be transmitted beyond device 10 without encryption. Thus in non-secure mode, what is displayed in regions 190, 200 may invite user input of non-private data, for example input such as invited by virtual keys 140 in FIG. 3. In secure mode, any information input by the user to regions 190 and 200 may be suppressed. As such, region(s) 190, 200 are utilized to capturing non-confidential user information only.

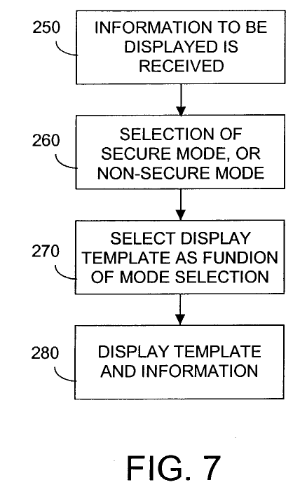

FIGS. 6 and 7 are exemplary flow diagrams for a device 10, according to the present invention. The method steps show in these figures may be performed in a different sequence and more or fewer steps can be provided.

FIG. 6 depicts exemplary steps to selectively display an input pad partition template according to one embodiment of the present invention. At step 210, information for display is received by transaction device 10, for presentation to a user on display/input screen 20. At step 220, a mode of operation is selected between secure mode and non-secure mode. At step 230, a template is selected based on the display information and the mode of operation. For example if non-secure mode is selected at step 220, then the template selected may be as shown in FIG. 3. On the other hand, if secure mode is selected at step 220, the template selected may instead be as shown in FIG. 4. At step 240 in FIG. 6, display/input screen 20 presents the template and display information for user-interface with device 10.

FIG. 7 is a flow diagram depicting selective encryption of input information received from a user interacting with display/input screen 20 on a transaction device 10, according to the present invention. At step 250, transaction device 10 receives information as to secure or non-secure mode of operation, perhaps from step 220 in FIG. 6. At step 260, transaction device 10 receives user input information corresponding to specific locations on display/input screen 20, for example (x,y) coordinates that represent a virtual PIN pad displayed in secure mode. At step 270, transaction device 10 selectively encrypts the input information to be transmitted remotely, based upon the specific location of the input information on display/input screen 20, and based upon the secure or non-secure operation mode of transaction device 10. At step 280, transaction device 10 selectively transmits the information input by the user to remote device(s) or system(s) 50, based upon the specific location of the input information on display/input screen 20, and based upon the secure or non-secure operation mode of transaction device 10.

Modifications and variations may be made to the disclosed embodiments without departing from the subject and spirit of the invention, as defined by the following claims.

What is claimed is:

1. A transaction device to receive user-input data and to transmit at least some of said user-input data, the transaction device comprising:
a user-interfaceable surface defining a first portion and a second portion;
a processor coupled to said user-interfaceable surface to selectively encrypt user-input data input to said first portion of said user-interfaceable surface; and
means for outputting encrypted said user-input data.

2. The transaction device of claim 1, wherein said user-interfaceable surface is a display-input screen that can output information from said transaction device and can respond to user-interface.

3. The transaction device of claim 1, wherein said first portion displays a functional virtual input pad.

4. The transaction device of claim 1, wherein said device is selectively non-responsive to input made upon said second portion.

5. The transaction device of claim 1, wherein said device transmits data input to said second portion without encryption.

6. The transaction device of claim 1, wherein said user-interfaceable surface comprises a resistive film response to a change in pressure exerted by a user of said transaction device.

7. The transaction device of claim 1, wherein said user-interfaceable surface is responsive to heat associated with user-interface with said transaction device.

8. The transaction device of claim 1, wherein said user-interfaceable surface comprises material responsive to pressure exerted with user-interface with said transaction device.

9. The transaction device of claim 1, wherein said user-interfaceable surface is responsive to changes in light resulting from user-interface with said transaction device.

10. The transaction device of claim 1, wherein said user-interfaceable surface is responsive to infrared energy resulting fro user-interface with said transaction device.

11. A transaction device comprising:
a screen to display information; and
a processor coupled to said screen to selectively format a user-viewable display upon said screen based upon an operating mode of said transaction device; and
means for outputting data from said transaction device.

12. The transaction device of claim 11, wherein said operating mode is selected is a secure mode.

13. The transaction device of claim 11, wherein said operating mode is a non-secure mode.

14. The transaction device of claim 11, wherein:
said operating mode is a secure mode; and
private user data input to said transaction device is encrypted prior to transmission from said transaction device.

15. A method of processing user data input to a transaction device, comprising the following steps:
(a) receiving information to be displayed to a user of said transaction device;
(b) selecting a mode of operation for said transaction device, said mode selected from a group consisting of secure mode and non-secure mode;
(c) displaying on said transaction device a template based upon a mode of operation selected at step (b);
(d) selectively encrypting data input to said transaction device by a user based upon a template displayed at step (c); and
(e) outputting from said transaction device encrypted said data, based upon said template.

16. The method of claim 15, wherein step (d) includes selectively displaying on an input area of said transaction device a user-interface by which private information is input by said user to said transaction device.

17. The method of claim 15, wherein step (d) is determined by location on said template whereat data is input by said user.

18. A method of processing user data input to a transaction device, comprising the following steps:
(a) sensing an operating mode of said transaction device, said operating mode selected from a group consisting of secure mode and non-secure mode;
(b) displaying on an input area of said transaction device a first user-interface region that is activated in said secure mode;
(c) receiving on said first interface region data input by a user of said transaction device; and
(d) encrypting information received at step (c).

19. The method of claim 18, further including:
(e) outputting information encrypted at step (d) from said transaction device.

20. The method of claim 19, further including:
rendering said transaction device inoperative to data input by a user other than input to said first interface region.
